(19) United States
(12) Patent Application Publication
(10) Pub. No.: US 2010/0257905 A1
(43) Pub. Date: Oct. 14, 2010

(54) Reversible Rotating Door Lock Handle Structure

(76) Inventor: Miao-Hsueh TSAI, Taichung (TW)

Correspondence Address: Wang Law Firm, Inc., 4989 Peachtree Parkway,, Suite 200, Norcross, GA, 30092, US

(21) Appl. No.: 12/253,990

(22) Filed: Oct. 19, 2008

(30) Foreign Application Priority Data
Dec. 17, 2007 (TW) 096221480

(51) Int. Cl. E05B 65/00; E05B 1/00

(52) U.S. Cl. 70/91

(57) ABSTRACT

A Reversible rotating door lock handle structure is comprised of: A main body and an actuator which is installed in the containing space of the said main body. The said actuator has a longitudinal slot with a rack installed respectively at its two sides and a hook-piece. A shaft pipe is provided with at least one shifter for engaging with either slot side rack of the said actuator. A handle which has a shift-lever for inserting into the slot of the said actuator and connected to the said hook-piece, thereby to push the actuator to move longitudinally and further to drive the said shaft pipe to rotate, whereof the rotating direction of the said shaft pipe can be reversed if the shifter of the said shaft pipe is switched to engage with the rack at the other side of the said actuator.

### BACKGROUND OF THE INVENTION

(a) Field of the Invention

The invention is related to a door lock device, especially to a reversible rotating door lock handle structure.

(b) Description of the Prior Art

The conventional door lock handle structure is usually installed at one side of the door and mutually combined with a door lock, when the handle is rotated, the lock-tongue of the door lock is linked by the lock-bolt to move transversely, whereby to reach a opening lock status. However, as the direction of the lock-bolt rotation by the handle of the said door lock structure is fixed during installation, it is not applicable to the doors of different opening directions. Therefore, the left-turn only door lock structures and right-turn only door lock structures are separated in manufacture, so that each door lock structure is only limited to be installed on either the left-open door or right-open door respectively, whereof the two can not be used interchangeably.

Hence, two kinds of manufacture lines are required for the above said door lock handle structure that not only brings down the production efficiency, but also complicates the manufacturing process, whereby when the installer wants to install the said door lock handle structure on the door, as types of doors are varied, so is the number of corresponding door lock handle structures to be prepared that brings troubles to the installer.

### SUMMARY OF THE INVENTION

The main purpose of the invention is to provide a reversible rotating door lock handle structure which has characteristics of reversible rotation to apply on the left-open or right-open door simultaneously.

To achieve the aforesaid purpose, the invention provides a Reversible rotating door lock handle structure, which is comprised of: A main body which has a containing space and is provided with a through hole. An actuator which is installed in the containing space of the main body, whereof the said actuator can be longitudinally translated in the containing space of the main body, whereof the said actuator has a longitudinal slot and two sides of the said slot are respectively installed with racks and a hook-piece is installed at the corresponding end to the said racks of the said actuator. A shaft pipe for inserting into the slot of the said actuator is provided with a hole to form a hinge with the lock-bolt of the door lock. Further, the periphery of the said shaft pipe has at least one shifter for engaging with the rack at either side of the slot of the said actuator; A handle which has a shift-lever, the said shift-lever is through the hole of said main body to insert into the slot of the said actuator and connected to the hook-piece of the said actuator, whereby the said actuator is pushed by the said shift-lever to do longitudinal translation and the said shaft pipe is driven by the rack of the said actuator through engagement with the said shaft pipe to do rotation, whereof the rotating direction of the said shaft pipe 31 can be reversed if the sifter of the said shaft pipe is switched to engage with the rack at the other side of the said actuator.

### BRIEF DESCRIPTION OF THE DRAWINGS

FIG. 1 is a 3D explosion view of the invention.

FIG. 2 is a side sectional view of the invention showing that the handle is not applied with a force.

FIG. 3 is a front sectional view of the invention showing that the said handle is not applied with a force.

FIG. 4 is a side sectional view of the invention showing that the said handle is applied with a force.

FIG. 5 is a front sectional view of the invention showing that the said handle is applied with a force.

FIG. 6 is a sectional side view of the invention showing that the said shaft pipe is pulled up along the axis.

FIG. 7 is a sectional side view of the invention showing that the shaft pipe is pulled up along the axis and position of its shifters is adjusted.

FIG. 8 is a front view of the invention showing that the handle of a left-open door is not applied with a force.

FIG. 9 is a sectional front view of the invention showing that the handle of the a left-open door is applied with a force.

### DETAILED DESCRIPTION OF THE PREFERRED EMBODIMENTS

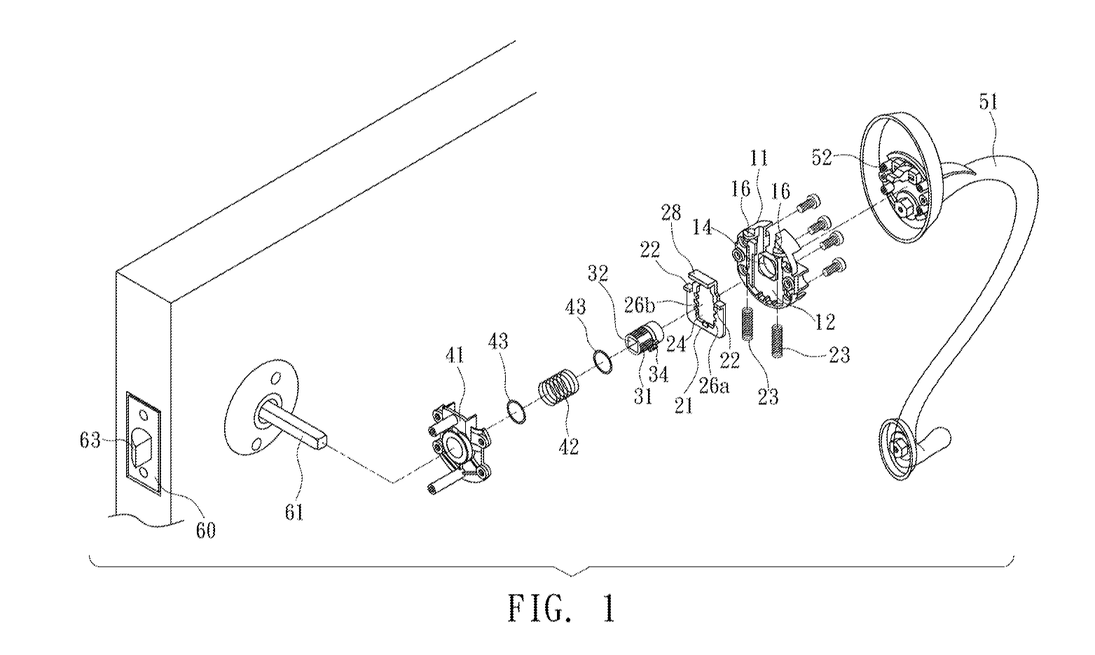

First please refer to FIG. 1, the embodying example provide a Reversible rotating door lock handle structure to link with the lock-bolt 61 of a door lock 60, in which the reversible rotating door lock handle structure is mainly comprised of a main body 11, an actuator 21, a shaft pipe 31, a cover piece 41 and a handle 51, whereof:

A main body 11 which has a containing space 12 and is provided with a through hole 14, whereof the containing space 12 of the main body 11 is installed with at least one limiter 16;

An actuator 21 which is installed in the containing space 12 of the main body 11, whereof the said actuator 21 can be longitudinally translated in the containing space 12 of the main body 11. The outside of the said actuator 21 is provided with at least one top support 22, a first spring 23 is installed between the limiter 16 of the main body 11 and the top support 22 at the outside of the said actuator 21 to provide a recovery spring force for the longitudinal translation of the said actuator 21 in the containing space 12 of the main body 11, whereof the said actuator 21 has a longitudinal slot 24 and two sides of the said slot 24 are respectively installed with racks 26a, 26b, and a hook-piece 28 is installed at the corresponding end to the said racks 26a, 26b of the said actuator 21.

A shaft pipe 31 for inserting into the slot 24 of the said actuator 24 is provided with a hole 32 to form a hinge with the lock-bolt 61 of the door lock 60. Further, the periphery of the said shaft pipe 31 is provided with multiple orderly arranged shifters 34 for engaging with the rack 26a at either side of the slot 24 of the said actuator 21, whereby the said shaft pipe 31 is driven by the said rack 26 to rotate along the axis.

A cover piece 41 for covering the main body 11, so that the said actuator 21 and the said shaft pipe 31 can be housed in the containing space 12 of the said main body 11, whereof the said shaft pipe 31 is installed with a second spring 42, one end of the said spring 42 is against the shifter 34 of the said shaft pipe 31, the other end is against the inside surface of the said cover piece 41, the two ends of the said second spring 42 are further respectively provided with a washer 43 to increase the contacting area of the second spring 42 against the shifter 34 of the said shaft pipe 31 as well as the inside surface of the said cover piece 41, thereby the shifter 34 of the said shaft pipe 31 is stably engaged with the rack 26a at either side of the said actuator 21 without slipping out of the said rack 26a;

A handle 51 which has a shift-lever 52, the said shift-lever 52 is through the hole 14 of the main body 11 to insert into the slot 24 of the said actuator 21 and connected to the hook-piece 28 of the said actuator, whereby the said actuator 21 is pushed by the said shift-lever 52 to do longitudinal translation and the said shaft pipe 31 is driven by the rack 26a of the said actuator 21 through engagement with shaft pipe 31 to do rotation, whereof the rotating direction of the said shaft pipe 31 can be reversed if the sifter 34 of the said shaft pipe 31 is switched to engage with the rack 26b of other side of the said actuator 21.

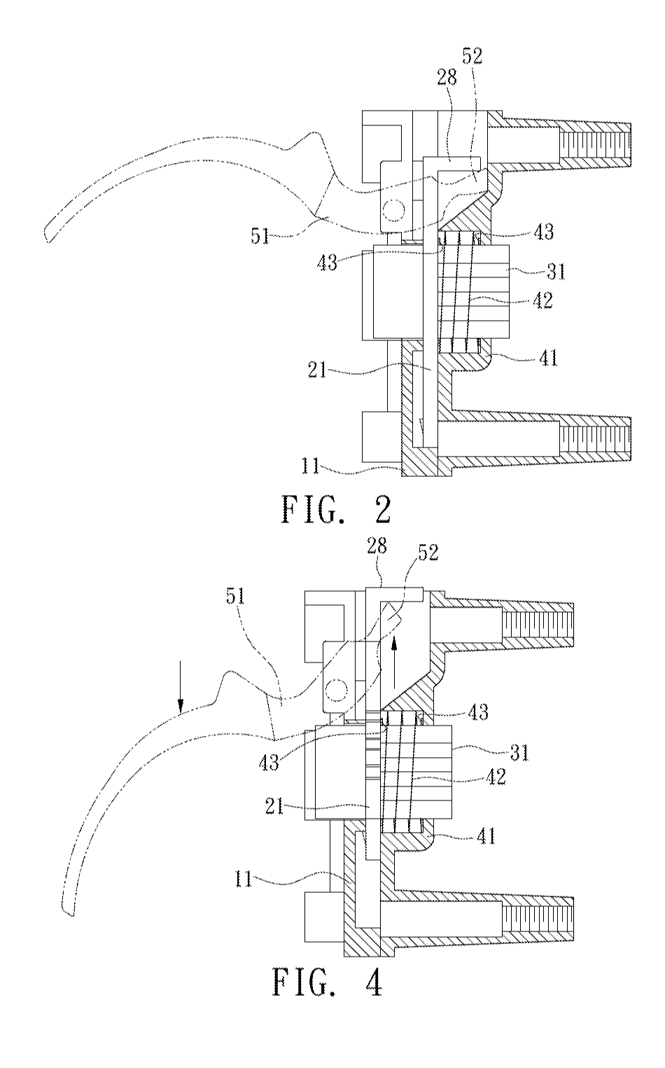

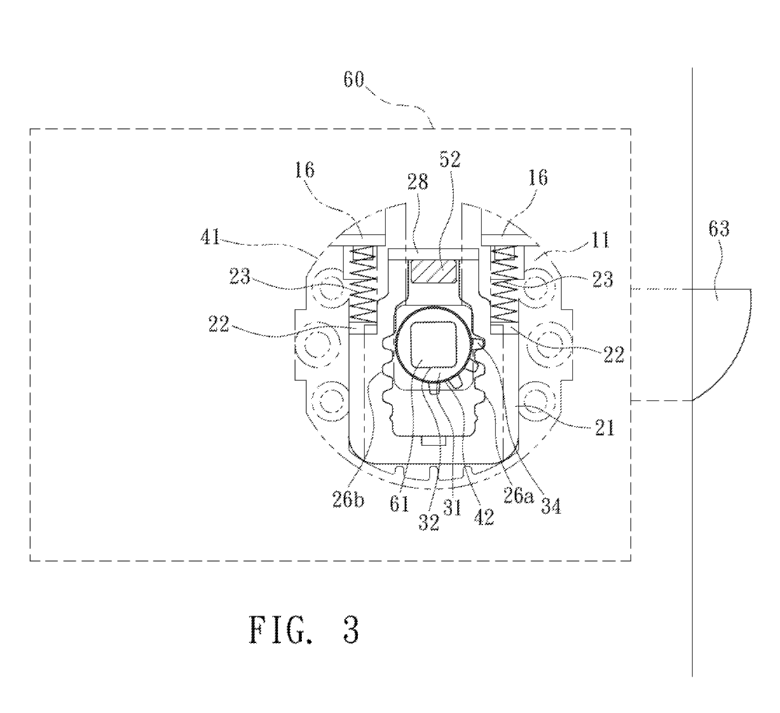

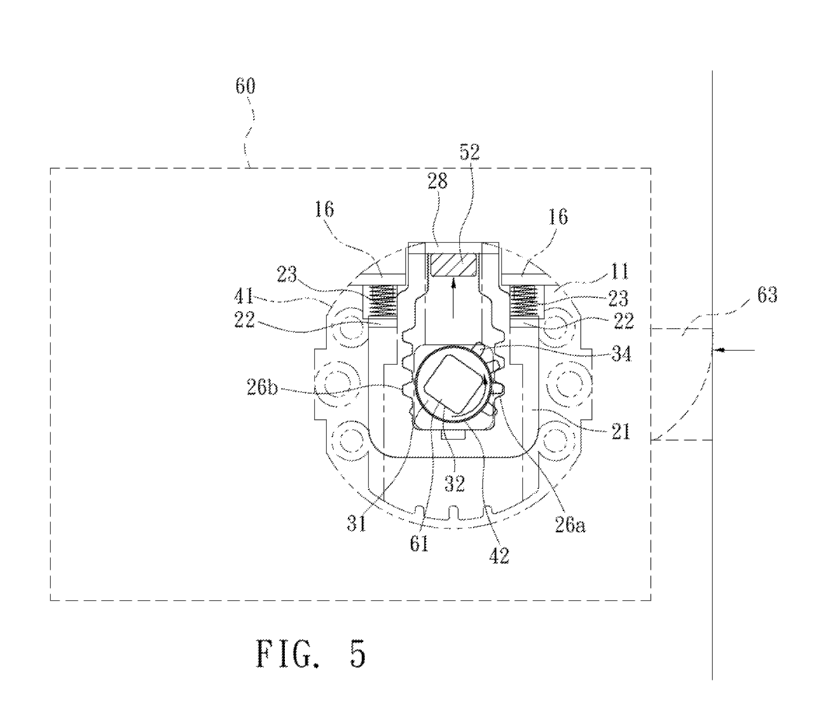

As shown in FIGS. 2 and 3, when the invention is installed to a right-open door, the said shaft pipe 31 is against by the second spring 42 so that its shifter 34 can be firmly engaged with the rack 26a at the right side of the said actuator 21; while as shown in FIGS. 4 and 5, when the operator applies an external force on the shift-lever 52 of the handle 51, the hook-piece 28 of the said actuator 21 is pushed by the said shift-lever 52 to translate upward, the said actuator 21 then compress the first spring 23 and is thus pushed to translate upward simultaneously, the shaft pipe 31 is then rotated counterclockwise due to that its shifter 34 driven by the rack 26a at right side of the said actuator 21, thereby the lock-bolt 61 hinged in the hole 32 of the said shaft pipe 31 is also rotated counterclockwise, and the lock-tongue 63 of the door lock 60 is driven by the said lock-bolt 61 to shrink inside the said door lock 60 to appear open-lock status. When the external force applied on the shift-lever 52 of the said handle 51 disappeared, the said actuator 21 is affected by the recovery force of the first spring 23 to translate downward, thereby to drive the said shaft pipe 31 and said lock-bolt 61 so that the lock-tongue 63 of the said door lock 60 is extended again out of the door lock 60 and recover back to the status shown in FIGS. 2 and 3.

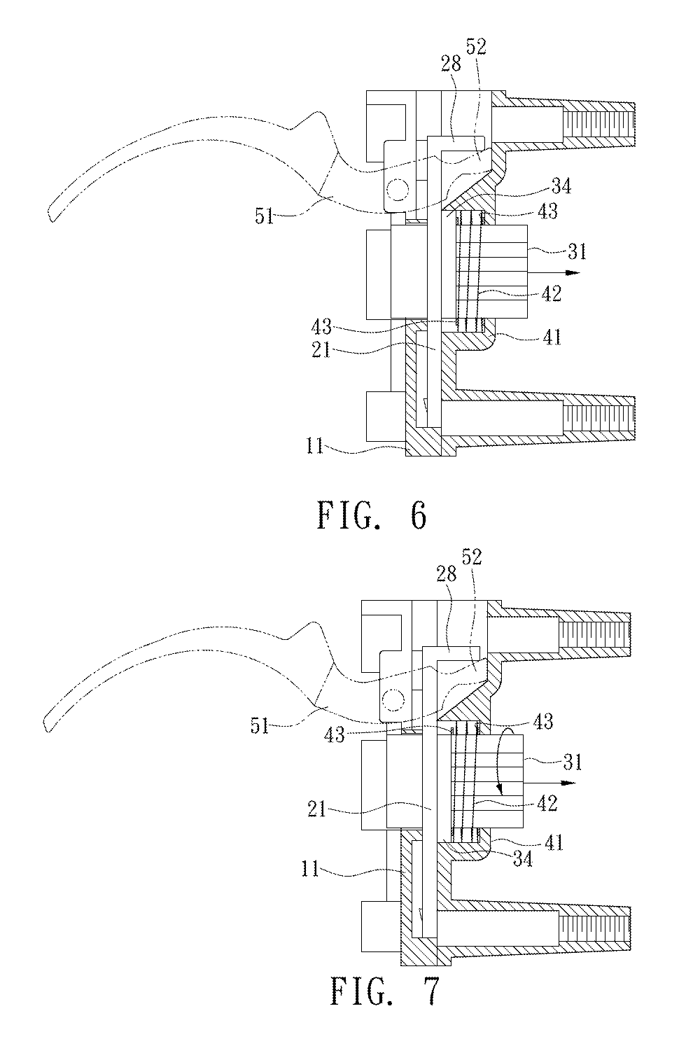

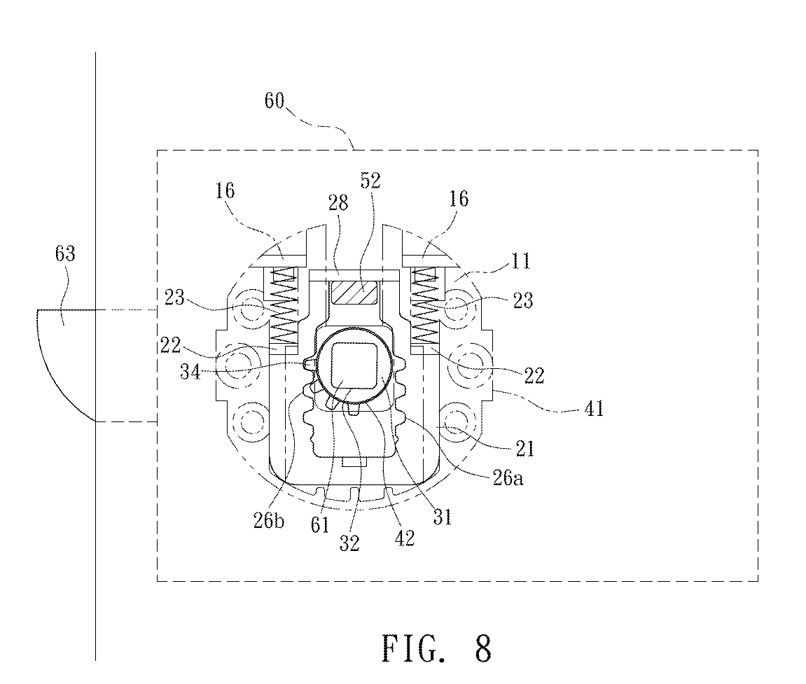

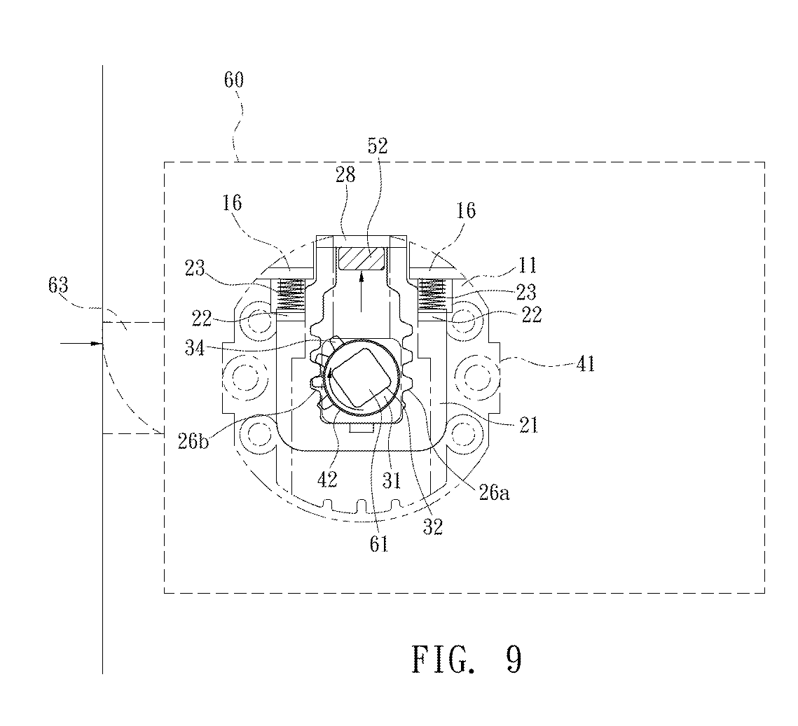

Please continue to refer to FIG. 6, the invention only requires to pull up the shaft pipe 31 along the axis, the said second spring 42 can be compressed to push the shifter 34 of the said shaft pipe 31 to release from the engagement with the rack 26a at the right side of the said actuator 21. Then the shifter 34 of the said shaft pipe 31 can be rotated to the rack 26b at the left side of the said actuator 21 as shown in FIGS. 7 and 8, whereby through the push of the second spring 42, the said shifter 34 of the shaft pipe 31 is changed to engage with the rack 26b at the left side of the actuator 21. Thereby, when the handle 51 is applied with a force as shown in FIG. 9, the shift-lever 51 is forced to push the said actuator to translate upward, the shifter 34 of the said shaft pipe 31 is then driven by the rack 26b at the left side of the said actuator 21 and changed to rotate clockwise. As such, the invention can then be installed to a left-open door. Therefore, through a simple adjustment on the position of the said shaft pipe 31, the invention provides the said shaft pipe 31 with a characteristic of reversible rotation to be used in the left-open or right-open door applications simultaneously.

1. Reversible rotating door lock handle structure which is comprised of:
A main body which has a containing space and is provided with a through hole.
An actuator which is installed in the containing space of the main body, whereof the said actuator can be longitudinally translated in the containing space of the main body, whereof the said actuator has a longitudinal slot and two sides of the said slot are respectively installed with racks and a hook-piece is installed at the corresponding end to the said racks of the said actuator;
A shaft pipe for inserting into the slot of the said actuator is provided with a hole to form a hinge with the lock-bolt of the door lock. Further, the periphery of the said shaft pipe is provided with multiple orderly arranged shifters for engaging with the rack at either side of the slot of the said actuator, whereby the said shaft pipe is driven by the said rack to rotate along the axis;
A handle which has a shift-lever, the said shift-lever is through the hole of said main body to insert into the slot of the said actuator and connected to the hook-piece of the said actuator, whereby the said actuator is pushed by the said shift-lever to do longitudinal translation and the said shaft pipe is driven by the rack of the said actuator through engagement with shaft pipe to do rotation, whereof the rotating direction of the said shaft pipe can be reversed if the sifter of the said shaft pipe is switched to engage with the rack of other side of the said actuator.

2. The reversible rotating door lock handle structure as in claim 1, whereof the containing space of the main body is installed with at least one limiter and the outside of the said actuator is provided with at least one top support, a first spring is installed between the limiter of the main body and the top support at the outside of the said actuator to provide a recovery spring force for the longitudinal translation of the said actuator in the containing space of the main body.

3. The reversible rotating door lock handle structure as in claim 1, whereof it has a cover piece for covering the said main body, so that the said actuator and the said shaft pipe can be housed in the containing space of the said main body.

4. The reversible rotating door lock handle structure as in claim 3, whereof the said shaft pipe is installed with a second spring, one end of the said spring is against the shifter of the said shaft pipe, the other end is against the inside surface of the said cover piece thereby the shifter of the said shaft pipe is stably engaged with the rack at either side of the said actuator without slipping out of the said rack.

5. The reversible rotating door lock handle structure as in claim 4, the two ends of the said second spring are further respectively provided with a washer to increase the contacting area of the second spring against the shifter of the said shaft pipe as well as the inside surface of the said cover piece.
